(19) United States
(12) Patent Application Publication
(10) Pub. No.: US 2006/0174228 A1
(43) Pub. Date: Aug. 3, 2006

(54) Adaptive pre-fetch policy

(75) Inventors: Ramesh Radhakrishnan, Austin, TX (US); Kong Loll Yang, Round Rock, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 11/046,277

(22) Filed: Jan. 28, 2005

(51) Int. Cl. G06F 9/44

(52) U.S. Cl. 717/127

(57) ABSTRACT

A user may establish initial hardware pre-fetch and second sector pre-fetch settings, including threshold values and enables status for each. Based on a comparison of various metrics associated with processor performance and the threshold values, the enable status of hardware and/or second sector pre-fetching may be changed without requiring a system reboot (or processor reinitialization).

### TECHNICAL FIELD

This disclosure relates generally to pre-fetching instructions or data into a cache accessible to a processor, and more particularly to changing the status of the processor's available pre-fetch policies based on monitored performance metrics.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Processors in many of these systems have the ability to obtain instructions or data from a main memory and place the instructions or data into a cache memory before the processor actually requires the instructions or data. Since most processors can access information from cache memory much faster than from main memory, improved system performance often results from the use of cache memories. Faster access to information stored in cache memory can reduce the number of processor cycles wasted waiting for information to be retrieved from an associated main memory.

Placing data or instructions into a cache before the data or instructions are actually needed by the processor is sometimes referred to as pre-fetching. In general, pre-fetching may be performed in response to a software command, sometimes referred to as software pre-fetching, or the ability to pre-fetch may be hardwired into a processor and performed by the processor without requiring a software pre-fetch command. This second type of pre-fetching is often referred to as hardware pre-fetching, and provides the benefit of being transparent to a program of instructions being executed by a processor. Thus, for software pre-fetching the person writing the program being executed on the processor, or the compiler of that program, must manage pre-fetches. Hardware pre-fetching allows the benefits of pre-fetching without requiring the programmer or the compiler to manage the pre-fetches.

When instructions or data are pre-fetched into a cache, most modern processors pre-fetch more than one word of instructions or data. The number of words pre-fetched at a particular time is normally determined by the size of the cache line implemented in a particular cache. Thus, a cache for use with a 16-bit processor may pre-fetch four data or instruction words at a time, and is said to have a 64-bit cache line. Other cache line sizes may be implemented, so that a cache used with a 16-bit processor may have a cache line of 16 bits, 32 bits, 64 bits, 128 bits, etc., depending on the number of words to be pre-fetched at a particular time. While pre-fetching more words at any particular time often improves the performance of the processor, in other instances pre-fetching too many words may decrease the performance of the cache.

At least one commercial processor provides a function referred to as a second sector pre-fetch, which allows processors to effectively divide the cache line of a cache into two parts—a first sector and a second sector. If second sector pre-fetch is enabled, then sufficient data or instructions are pre-fetched at a single time to fill the entire cache line, i.e. both the first sector and the second sector. If second sector pre-fetch is disabled, however, only sufficient data or instructions to fill the first sector of the cache line are pre-fetched at any one time. By providing a way to enable or disable second sector pre-fetch, the amount of data or number of instructions pre-fetched at any one time, whether in response to a software command or employing a hardware pre-fetch, can be controlled.

Similar enable/disable functionality is provided by most processors for hardware pre-fetch functionality. Thus, depending on whether hardware pre-fetching is enabled or disabled, hardware pre-fetching can be set to provide improved processor efficiency when the hardware configuration of the system in which the processor is installed is known.

### SUMMARY

In accordance with teachings of the present disclosure, a system, method, and software for use in an information handling system capable of implementing both hardware pre-fetch and second sector pre-fetch operations is described.

A method according to an embodiment of the present disclosure includes setting a hardware pre-fetch value, a second sector pre-fetch value, or both the hardware and second sector pre-fetch values, to values supplied by an information handling system user. Performance of the processor is monitored using any of various metrics, including various throughput, latency, queue depth, and/or cache load-and-store miss ratios, to determine if the performance of the processor is being adversely affected by the pre-fetch settings. If performance of the processor is being adversely affected by either the hardware pre-fetch setting or the second sector pre-fetch setting, one of the pre-fetch settings may be changed without rebooting the information handling system.

Some methods disclosed herein, may change one of the hardware or second sector pre-fetch values if a metric exceeds a pre-determined threshold value. This pre-determined threshold value may be supplied as one of the hardware pre-fetch values supplied by the user. In addition to supplying threshold values, a user may set values indicating whether hardware pre-fetch and/or second sector pre-fetch functions are to be enabled or disabled. In some such embodiments, hardware pre-fetch and second sector pre-fetch may be selectively enabled or disabled during operation of an information handling system without rebooting the information handling system.

Another embodiment of the disclosure provides an information handling system including a processor capable of implementing both hardware pre-fetch operations and second sector pre-fetch operations, memory connected to the processor, one or more levels of cache having cache lines with first and second sectors, and a program of instructions. According to at least one embodiment, the program of instruction includes an instruction to set a hardware pre-fetch value and a second sector pre-fetch value to a user supplied value, and an instruction to monitor processor performance. The program of instructions may also include an instruction to determine if the performance of the processor is adversely affected by either the hardware pre-fetch value or the second sector pre-fetch value, and an instruction to change one or both of the pre-fetch values, as needed, without rebooting the information handling system.

Other embodiments of the present disclosure take the form of a computer readable medium tangibly embodying a program of executable instructions for use in an information handling system capable of implementing both hardware pre-fetch and second sector pre-fetch operations. The program of instructions may perform any of various methods discussed herein or their equivalents. Part or all of the program of instructions may be included in a basic input output system (BIOS). In other embodiments, the program of instructions may be stored in system memory, on a removable medium, or otherwise.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of a system capable of changing user-provided default pre-fetch settings during operation of the system, without requiring a system re-boot, according to an embodiment of the present disclosure.

FIG. 2 is a block diagram of a system illustrating information flow between a cache, a processor, and system memory according to an embodiment of the present disclosure.

FIG. 3 is a flow diagram illustrating a method according to an embodiment of the present disclosure.

### DETAILED DESCRIPTION

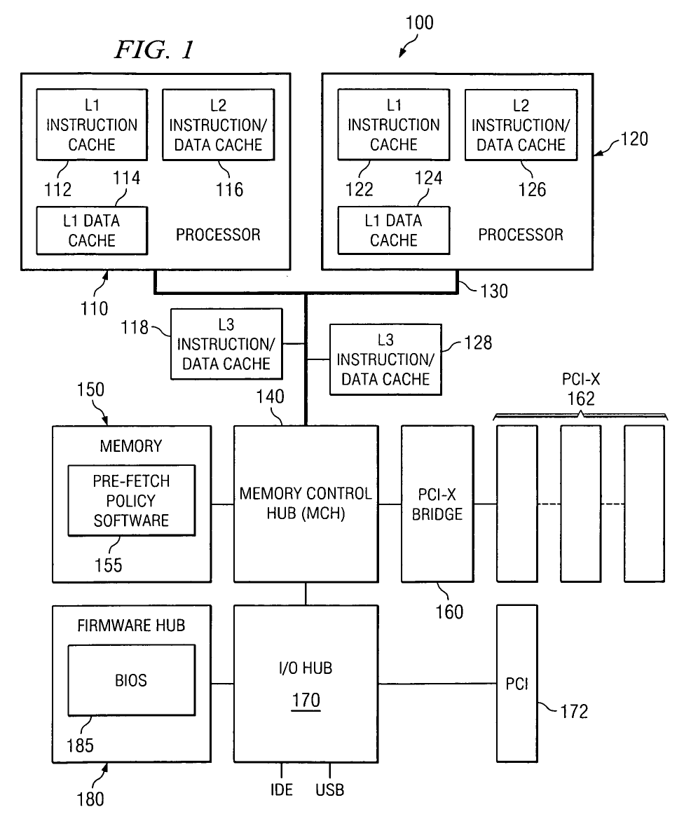

Preferred embodiments and their advantages are best understood by reference to FIGS. 1 through 3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, one such information handling system is illustrated, and designated generally as system 100. System 100 includes processors 110 and 120 connected via front side bus 130 to Memory Control Hub (MCH) 140. Processors 110 and 120 are also connected to level 3 (L3) instruction/data cache 118 and 128. MCH 140 is connected to memory 150, I/O Hub 170, and peripheral control interconnect-extensible (PCI-X) bridge 160. Memory 150 generally includes RAM used to store instructions and data for use by processors 110 and 120. In the illustrated embodiment, memory 150 may be used to hold pre-fetch policy software 155, which will be discussed subsequently in greater detail.

PCI-X bridge 160 interfaces with PCI-X bus 162 to permit use of compatible peripherals with system 100. I/O Hub 170 is connected to firmware Hub 180 and peripheral control interconnect (PCI) bus 172. PCI bus 172, like PCI-X bus 162, allows connection of various peripherals to system 100. Firmware Hub 180 may include, in at least one embodiment, BIOS 185, which may be used to store user specified threshold values, processor pre-fetch settings, or the like. In some embodiments, I/O Hub 170 is also connected to input/output devices via a universal serial bus (USB) (not illustrated) and an integrated device electronics (IDE) bus (not illustrated).

Processors 110 and 120 each include a level 1 (L1) instruction cache 112 or 122, respectively, an L1 data cache 114 or 124, respectively, and a level 2 (L2) instruction/data cache 116 or 126, respectively. Under many circumstances, L1 and L2 instruction and data caches allow processor 110 and 120 to access data and instructions faster than would otherwise be possible if each processor had to obtain the same instructions and data from memory 150. L3 instruction/data caches 118 and 128 are associated with respective processors 110 and 120, and may also provide faster access to data and instructions in some instances. Processors 110 and 120 may also be coupled to one or more shared caches (not illustrated).

In operation, processors 110 and 120 may operate more efficiently under some circumstances if the L1-L3 caches are used to store pre-fetched data or instructions. For example, a speculative load instruction may be used to pre-fetch instructions or data from memory 150 into one or more of the caches 112-118, so that processor 110 will have quick access to the data or instructions likely to be needed next. If processor 120 has previously pre-fetched any needed instructions or data, information can be delivered to caches 112-118 in response to the load instruction being executed by processor 110 without delay.

In some cases, however, using pre-fetch can have an adverse impact on system performance. Assume, for example, that processor 110 begins to pre-fetch data to fill its associated caches. Since the front-side bus (FSB) 130 is shared between processors 110 and 120, only one processor can transfer data on the FSB at any one time. If, during the time processor 110 is pre-fetching data, processor 120 needs to perform a non-speculative load processor 120 may have to wait for the speculative load being performed by processor 110 to complete before obtaining data or instructions from the non-speculative load. This can result in a process that should be performed immediately (processor 120's load) being delayed by a speculative process (processor 110's pre-fetch). Thus, even though pre-fetching may often improve processor performance, the example above presents a situation in which pre-fetching instructions or data can have an adverse impact on processor performance.

Pre-fetch policy software 155 can be used to monitor the performance of one or more processors, and to enable or disable various types of pre-fetching as indicated by processor performance metrics. So, for example, if the performance of processors 110 and 120 can be improved by enabling hardware pre-fetch and second sector pre-fetch, then pre-fetch policy software can enable both types of pre-fetching. If performance metrics indicate that only second sector pre-fetch should be enabled, then hardware pre-fetch can be disabled. Conversely, second sector pre-fetch may be disable while hardware pre-fetching is enabled.

In some embodiments, the initial state of hardware and second sector pre-fetch is determined by user selected preferences. These preferences may be stored in BIOS 155, in a system memory 150 or elsewhere. These user preferences may include various thresholds designating how pre-fetch policy software 155 is to handle certain specified conditions, e.g. a particular threshold may specify that upon a performance metric reaching a particular level indicative of a desired level of performance, the pre-fetch policy may be adaptively updated. In some such embodiments, the pre-fetch settings and/or threshold levels may be changed automatically by pre-fetch policy software 155 without requiring a re-boot of system 100.

Note that although system 100 is illustrated as including two main processors sharing a common front-side bus 130, in other embodiments a single central processor may be used to implement the teachings set forth herein. Likewise, three or more processors may be employed in other embodiments, each with various cache configurations.

Consider the following two examples illustrating how varying pre-fetch policy affects processor performance.

### EXAMPLE 1

TPC-C (a widely used database benchmark for Servers)was used to evaluate a four processor system with 8 logical processors (P0 . . . P7), wherein SS=Second Sector, and HW=Hardware Pre-fetch. Performance for each of the four possible settings are describe below:

1. SS:off HW:off

This produced the best tpmC (transactions per minute) rate and the best average Response Time (RT) for new orders (N.O.).

2. SS:off HW:on

TpmC decreased by only 0.6% and the average RT for N.O. was almost identical the SS:off and HW:off case.

3. SS:on HW:off

TpmC decreased by 5.6% and the average RT for N.O. doubled.

4. SS:on HW: on

Worst tpmC. TpmC decreased by 9% and the average RT for N.O. tripled.

### EXAMPLE 2

SPECjbb2000 Benchmark (Java Server benchmark) was used to evaluate performance of a four processor system with 8 logical processors (P0 . . . P7), wherein SS=Second Sector, and HW=Hardware Pre-fetch, and tpm=transactions per minute (higher is better). Performance for the system running SPECjbb2000 under each of the four possible settings is described below.

1. HW:off SS:off yielded 62,881 tpm (−8%)

2. HW:off SS:on yielded 67,862 tpm (best performance)

3. HW:on SS:off yielded 63,639 tpm. (−6%)

4. HW:on SS:on yielded 66,065 tpm (−1%)

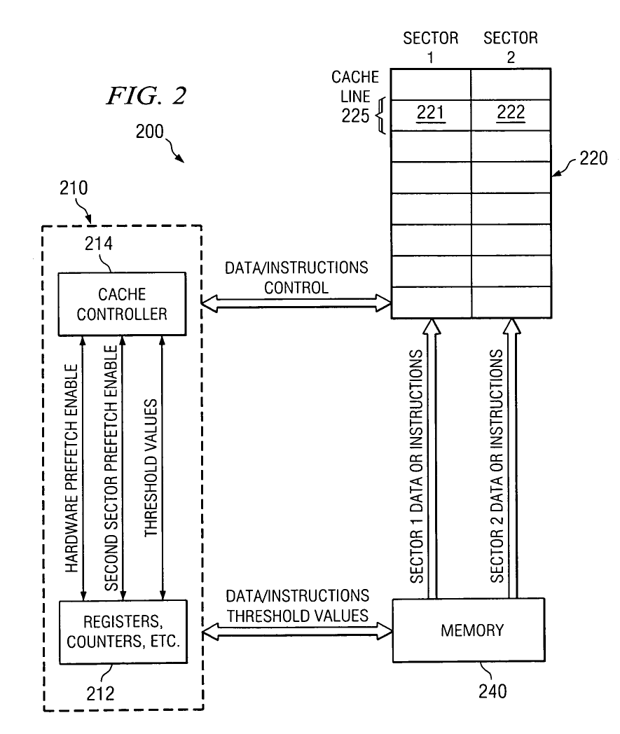

Referring next to FIG. 2, a system 200 will be discussed according to an embodiment of the present invention. System 200 includes processor 210, cache 220, and memory 240. Processor 210 includes cache controller 214 and registers/counters 212. Registers/counters 212, in one embodiment, hold threshold values related to hardware pre-fetch and second sector pre-fetch, as well as enable/disable values associated with hardware and second sector pre-fetch. The threshold values may be initially loaded into registers/counters 212 from memory 240, which is, in one embodiment, system memory. In other embodiments, threshold values held in registers/counters 212 may be obtained from a system BIOS upon initial power-up of system 200.

It should be appreciated that these threshold values may be determined by a user of system 200 based on the user's knowledge of system performance, or some other user preference. While some embodiments provide for factory set threshold values to be held in registers/counters 212, a preferred embodiment employs user designated threshold values.

These threshold values may be associated with various processor performance metrics, such as front-side data bus (FSB) throughput, bus sequencing unit (BSQ) latency, FSB latency, FSB average queue depth, BSQ average queue depth, the threshold values may be related to MESI (Modified Shared Exclusive Invalid) data for various cache levels. So, for example, the threshold values may be related to second level (L2) cache load-and-store miss ratios, L2 cache hits shared ratio, L2 cache hits exclusive ratio, L2 cache modified ratio, third level (L3) cache load-and-store miss ratios, L3 cache hits share ratio, 3M cache hits exclusive ratio, L3 cache modified ratio, transactions per minute, and/or response time for new orders. For example, counters in registers/counters 212 may be used to count the number of cache transactions associated with cache 220 that occur during a one minute period. Likewise, when cache commands are sent to cache 220, the time it takes to complete the cache transaction can be measured, recorded in registers/counters 212, and the average response time for completion of the transactions determined.

In these examples, if a threshold value set by a user indicates that second sector pre-fetch should be disabled when the number of transactions per minute exceeds a desired value, registers/counters 212 can provide both the threshold value and the number of counts to cache controller 214, which compares the user threshold value to the number of transactions per minute. Cache controller 214 may generate a signal indicating that second sector pre-fetch should be disabled based on its comparison. So, for example, if cache controller 214 determines that second sector pre-fetch should be disabled, processor 210 may send a control signal to cache 220 disabling the second sector pre-fetch.

In other embodiments, processor 210 may notify memory 240 that second sector pre-fetch is to be disabled, thereby causing memory 240 to supply only the first sector of data or instructions to cache 220 rather than supplying both the first and second sector of data or instructions. Additionally, cache controller 214 may reset, or change the values in register/counters 212, particularly the values indicating that hardware pre-fetch or second sector pre-fetch are enabled/disabled.

In some embodiments, cache controller 214 may also change threshold values held in registers/counters 212. For example, if processor 210 is capable of implementing three different hardware pre-fetch algorithms, then cache controller 214 may set a value in one of the registers or counters in registers/counters 212 indicating which type of hardware pre-fetch is to be enabled or disabled. Cache controller 214 may also change a threshold value at which processor 210 switches over from using a first type of hardware pre-fetch algorithm to a second type of hardware pre-fetch algorithm. In some embodiments, threshold values set by a user may not be changed by cache controller 214 unless specifically permitted by a user.

Consider another example of the operation of system 200 according to an embodiment of the present disclosure. Assume for purposes of this example that a user has specified that hardware pre-fetch and second sector pre-fetch are to be enabled initially, but second sector pre-fetch is to be disabled whenever the front side data bus throughput drops by more than 10% of maximum. Initially, when processor 210 initiates a hardware pre-fetch of data or instructions into cache 220, data or instructions will be pre-fetched into both first sector 221 and second sector 222 of cache line 225.

If the front side bus data throughput falls to less than 10% of its maximum, however, cache controller 214 may send a control signal to cache 220 notifying cache 220 to enter a mode in which second sector pre-fetch is not used. Cache controller 214 may also reset one or more values stored in registers/counters 212, e.g. an enable bit, to indicate that second sector pre-fetch has been disabled. In such a case, data or instructions sent from memory 240 to cache 220 would only be delivered for the first sector 221 of cache line 225.

Cache controller 214 may also control the enable/disable function of hardware pre-fetch based on one or more threshold values set by a user, or otherwise. In at least one embodiment, even though hardware pre-fetch is disabled, a software pre-fetch command executed by processor 210 would still cause memory 240 to supply both sector one and sector two data/instructions to cache 220. If, however, both hardware pre-fetch and second sector pre-fetch are disabled, a software pre-fetch instruction issued by processor 210 would cause sector one data/instructions only to be loaded into cache 220.

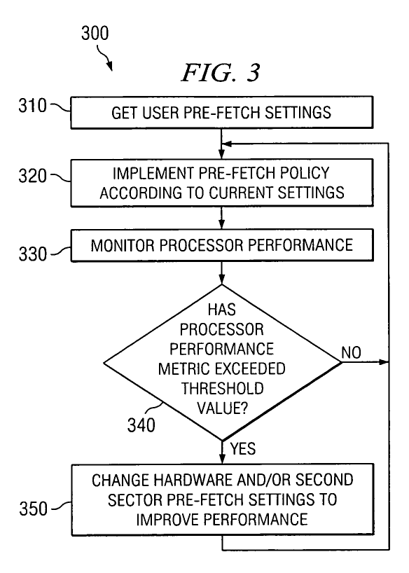

Referring next to FIG. 3, a method according to an embodiment of the present disclosure will be discussed. Method 300 begins at 310, where user pre-fetch settings are obtained. The user-designated pre-fetch settings may be obtained in some embodiments from a BIOS, from main memory, from designated registers within a processor that have been set according to user instructions, or otherwise. These pre-fetch settings, as noted earlier, may include settings indicating whether hardware pre-fetch or second sector pre-fetch functions are enabled, or thresholds used to determine when hardware pre-fetch and second sector pre-fetch functions should be disabled or enabled.

The method proceeds to 320, where a processor pre-fetch policy is implemented according to the current settings obtained at 310. Thus, if the user settings indicate that hardware pre-fetch should be enabled while second sector pre-fetch should be disabled, the processor pre-fetch policy will be implemented so that hardware pre-fetch is enabled, but only first sector data will be retrieved in response to a hardware pre-fetch.

Method 300 monitors the performance of the processor at 330 to determine whether the pre-fetch policy as initially implemented is optimum. As noted earlier, various performance metrics associated with either the processor, cache, or memory may be monitored.

The method proceeds to 340, where the monitored performance is compared to threshold values specified by a user. Although in some embodiments the threshold values may be specified by a manufacturer or otherwise, at least one preferred embodiment employs user supplied threshold values. Based on a comparison between one or more measured performance metrics and one or more corresponding user supplied threshold values, method 300 determines whether the pre-fetch policy should be changed. If the performance metrics do not exceed the specified user threshold values, the method flows from 340 back to 320, where the current pre-fetch policy is implemented and performance is again monitored at 330 and checked at 340.

If, however, a processor performance metric has exceeded the threshold value specified by the user, the method proceeds to 350 where the pre-fetch policy of the processor is changed. Thus, if a user threshold specifies that hardware pre-fetch should be disabled upon any of the second or third level cache load-to-store miss ratios exceeding 20%, then the hardware pre-fetch value will be changed accordingly.

After the hardware and/or second sector pre-fetch values are changed at 350, the method returns to 320 where the new pre-fetch policy is implemented according to the revised settings. Note that unlike some conventional methods which may require a system reboot (or processor reinitialization)when pre-fetch policies are changed, a preferred embodiment of the present disclosure does not require a system reboot (or processor reinitialization)to implement changes in the hardware or second sector pre-fetch policy consequently, either hardware or second sector pre-fetch may be enabled or disabled in an adaptive manner without rebooting the system.

It should be appreciated that although various functions have been illustrated and discussed in a particular order with reference to method 300, other methods may be implemented employing more or fewer functions. Additionally, some embodiments may perform the functions of method 300 in order different than that illustrated, where appropriate.

Although the disclosed embodiments have been described in detail, it should be understood that various changes, substitutions and alterations can be made to the embodiments without departing from their spirit and scope.

What is claimed is:

1. A method for use in an information handling system capable of implementing both hardware pre-fetch and second sector pre-fetch operations, the method comprising:
setting at least one of a hardware pre-fetch value and a second sector pre-fetch value to a user supplied value;
monitoring performance of a processor;
determining if the performance of the processor is adversely affected by one of the hardware pre-fetch value or the second sector pre-fetch value based on the monitoring; and
without re-booting the information handling system, changing at least one of the hardware pre-fetch value and the second sector pre-fetch value in response to the determination.

2. The method of claim 1, wherein the setting at least one of a hardware pre-fetch value and a second sector pre-fetch value to a user supplied value comprises establishing predetermined threshold values.

3. The method of claim 2, wherein the determining comprises comparing monitored processor performance to the predetermined threshold values.

4. The method of claim 3, wherein the changing at least one of the hardware pre-fetch value and the second sector pre-fetch value comprises modifying register values if processor performance indicators exceed one or more of the predetermined threshold values.

5. The method of claim 1, further comprising:
placing information in both first and second sectors of a cache line in response to a software pre-fetch command if the second sector pre-fetch value indicates that second sector pre-fetch is enabled; and
placing information in only a first sector of a cache-line in response to a software pre-fetch command if the second sector pre-fetch value indicates that second sector pre-fetch is disabled.

6. The method of claim 1, further comprising:
placing information in both first and second sectors of a cache line in response to a hardware pre-fetch if both the hardware pre-fetch and the second sector pre-fetch are enabled; and
placing information in only a first sector of a cache-line in response to a hardware pre-fetch if the hardware pre-fetch is enabled and the second sector pre-fetch value is disabled.

7. The method of claim 1, wherein the monitoring comprises monitoring one or more metrics selected from the list consisting of:
front-side data bus (FSB) throughput,
bus sequencing unit (BSQ) latency,
FSB latency,
FSB average queue depth,
BSQ average queue depth,
second level (L2) cache load and store miss ratios,
L2 cache hits shared ratio,
L2 cache hits exclusive ratio,
L2 cache hits modified ratio,
third level (L3) cache load and store miss ratio,
L3 cache hits shared ratio,
L3 cache hits exclusive ratio and
L3 cache hits modified ratio,
transactions per minute, and
response time for new orders.

8. An information handling system comprising:
a processor capable of implementing both hardware pre-fetch operations and second sector pre-fetch operations;
memory operably associated with said processor;
a cache coupled to said processor and said memory, said cache comprising a plurality of cache lines including first and second sectors; and
a program of executable instructions to be stored in said memory and executed by said processor, said program of instructions comprising:
at least one instruction executable to set at least one of a hardware pre-fetch value and a second sector pre-fetch value to a user supplied value;
at least one instruction executable to monitor performance of the processor and provide an indication thereof;
at least one instruction executable to determine, based on the indication, if the performance of the processor is adversely affected by one of the hardware pre-fetch value or the second sector pre-fetch value; and
at least one instruction executable to change at least one of the hardware pre-fetch value and the second sector pre-fetch value, based on the determination, without re-booting the information handling system.

9. The information handling system of claim 8, wherein the at least one instruction to set at least one of a hardware pre-fetch value and a second sector pre-fetch value to a user supplied value comprises at least one instruction executable to establish predetermined threshold values.

10. The information handling system of claim 9, wherein the at least one instruction to determine comprises at least one instruction executable to compare monitored processor performance to the predetermined threshold values.

11. The information handling system of claim 10, wherein the at least one instruction to change at least one of the hardware pre-fetch value and the second sector pre-fetch value comprises at least one instruction executable to modify register values if the performance of the processor exceeds one or more of the predetermined threshold values.

12. The information handling system of claim 8, wherein said information handling system is configured to:
place information in both first and second sectors of a cache line in response to a software pre-fetch command if the second sector pre-fetch value indicates that second sector pre-fetch is enabled; and
place information in only a first sector of a cache-line in response to a software pre-fetch command if the second sector pre-fetch value indicates that second sector pre-fetch is disabled.

13. The information handling system of claim 8, wherein said information handling system is configured to:
place information in both first and second sectors of a cache line in response to a hardware pre-fetch if both the hardware pre-fetch and the second sector pre-fetch are enabled; and
place information in only a first sector of a cache-line in response to a hardware pre-fetch if the hardware pre-fetch is enabled and the second sector pre-fetch value is disabled.

14. The information handling system of claim 8, wherein the at least one instruction to monitor comprises at least one instruction executable to monitor one or more metrics selected from the list consisting of:
front-side data bus (FSB) throughput,
bus sequencing unit (BSQ) latency,
FSB latency,
FSB average queue depth,
BSQ average queue depth,
second level (L2) cache load and store miss ratios,
L2 cache hits shared ratio,
L2 cache hits exclusive ratio,
L2 cache hits modified ratio,
third level (L3) cache load and store miss ratio,
L3 cache hits shared ratio,
L3 cache hits exclusive ratio,
L3 cache hits modified ratio,
transactions per minute, and
response time for new orders.

15. A computer readable medium tangibly embodying a program of executable instructions for use in an information handling system capable of implementing both hardware pre-fetch and second sector pre-fetch operations, said program of instructions comprising:
at least one instruction executable to set at least one of a hardware pre-fetch value and a second sector pre-fetch value to a user supplied value;
at least one instruction executable to monitor performance of a processor and provide an indication thereof;
at least one instruction executable to determine if the performance of the processor is adversely affected by one of the hardware pre-fetch value or the second sector pre-fetch value based on the indication; and
at least one instruction executable to change at least one of the hardware pre-fetch value and the second sector pre-fetch value in response to the determination and without re-booting the information handling system.

16. The computer readable medium of claim 15, wherein the at least one instruction to set at least one of a hardware pre-fetch value and a second sector pre-fetch value to a user supplied value comprises at least one instruction executable to establish predetermined threshold values.

17. The computer readable medium of claim 16, wherein the at least one instruction to determine comprises at least one instruction executable to compare monitored processor performance to the predetermined threshold values.

18. The computer readable medium of claim 17, wherein the at least one instruction to change at least one of the hardware pre-fetch value and the second sector pre-fetch value comprises at least one instruction executable to modify register values if processor performance indicators exceed one or more of the predetermined threshold values.

19. The computer readable medium of claim 15, wherein the information handling system is configured to:
place information in both first and second sectors of a cache line in response to a software pre-fetch command if the second sector pre-fetch value indicates that second sector pre-fetch is enabled; and
place information in only a first sector of a cache-line in response to a software pre-fetch command if the second sector pre-fetch value indicates that second sector pre-fetch is disabled.

20. The computer readable medium of claim 15, wherein said information handling system is configured to:
place information in both first and second sectors of a cache line in response to a hardware pre-fetch if both the hardware pre-fetch and the second sector pre-fetch are enabled; and
place information in only a first sector of a cache-line in response to a hardware pre-fetch if the hardware pre-fetch is enabled and the second sector pre-fetch value is disabled.

21. The computer readable medium of claim 15, wherein the at least one instruction executable to monitor comprises at least one instruction executable to monitor one or more metrics selected from the list consisting of:
front-side data bus (FSB) throughput,
bus sequencing unit (BSQ) latency,
FSB latency,
FSB average queue depth,
BSQ average queue depth,
second level (L2) cache load and store miss ratios,
L2 cache hits shared ratio,
L2 cache hits exclusive ratio,
L2 cache hits modified ratio,
third level (L3) cache load and store miss ratio,
L3 cache hits shared ratio,
L3 cache hits exclusive ratio,
L3 cache hits modified ratio,
transactions per minute, and
response time for new orders.
